(19) United States
(12) Patent Application Publication
(10) Pub. No.: US 2009/0213220 A1
(43) Pub. Date: Aug. 27, 2009

(54) Active monitoring system with multi-spot image display and a method thereof

(76) Inventors: Tsung Chen, Taipei City (TW); Syin-Jwu Chen, Jhonghe City (TW); Zen-Tai Chang, Banciao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/081,265

(22) Filed: Apr. 14, 2008

(30) Foreign Application Priority Data
Feb. 27, 2008 (TW) 97106764

(51) Int. Cl. H04N 7/18

(52) U.S. Cl. 348/155; 348/E07.085

(57) ABSTRACT

An active monitoring system with multi-spot image display and a method thereof are disclosed. The active monitoring system includes at least one image-obtaining module, at least one image-receiving module, and at least one image-display module. The image-obtaining modules respectively obtain a dynamic image and generate a triggering signal according to the obtained dynamic image. The image-receiving modules are connected with the image-obtaining modules via a network. Each of the image-receiving modules is controlled by the triggering signal to receive and process the dynamic image. The image-display modules are respectively connected with the image-receiving modules and are controlled by the triggering signal to display the processed dynamic image.

### BACKGROUND OF THE INVENTION

1. Field of the Invention

The present invention relates to an active monitoring system with multi-spot image display and a method thereof. In particular, this invention relates to an active monitoring system with multi-spot image display and a method thereof that is digitized and applied to a household.

2. Description of the Related Art

As the information technology has been rapidly developed, the safety monitoring devices has been digitized and utilizes the network technology. Due to the safety monitoring devices has been digitized, the data can be easily processed and stored and the devices become more stable and are controllable. Because Internet and wide-band Internet become popular, the monitoring data can be transmitted more easily and rapidly. Therefore, the usage of network digital safety monitoring devices is a trend.

Network distributed remote safety monitoring system includes digital video servers (DVS), IP cameras, digital video audio servers (DVAS), and TCP/IP IO controllers, etc. All have a data transferring control interface on network, and have a standard network interface so that the cameras, the microphones, the digital output/input control devices can be easily linked to a network to become part of the network equipment.

Each part of the monitoring equipment is a device on a network. When the device is assigned an IP address, the device can be accessed via network and exchange data. When the device is linked to LAN/Internet, a network monitor or a remote monitor can be implemented via integrated system software.

Commonly, the receiving terminal of the monitoring system is a computer with a multiple frame display. Its structure is multiple-to-one (a plurality of video camera is transmitted to a computer via network). However, when the monitoring system is applied to a household, it is inadequately digitized. In a general household, the monitoring devices include computers, TVs, display screens, cell phones, etc. Therefore, if these monitoring devices are integrated to be a one-to-multiple (a video camera to a plurality of monitoring devices) or a multiple-to-multiple (a plurality of video camera to a plurality of monitoring devices) monitoring system, the household safety monitoring system can be complete and digitized.

### SUMMARY OF THE INVENTION

One particular aspect of the present invention is to provide a digital household safety monitoring system. The image detection monitoring system uses image movement detection technology to detect object movement. When the object moves, the video and audio signal can be immediately compressed and transmitted to the receiving and converting transmission system on network and to a display screen or a TV to show the living image in a picture in picture (PIP) mode or to inform the viewer of the TV by a scrolling banner.

The active monitoring system with multi-spot image display includes at least one image-obtaining module, at least one image-receiving module, and at least one image-display module. The image-obtaining modules respectively obtain a dynamic image and generate a triggering signal according to the obtained dynamic image. The image-receiving modules are connected with the image-obtaining modules via a network. Each of the image-receiving modules is controlled by the triggering signal to receive the corresponding dynamic image. The image-display modules are respectively connected with the image-receiving modules to display the corresponding dynamic image according to the triggering signal.

The active monitoring system with multi-spot image display further includes a main server. The main server is connected with each of the image-obtaining modules via the network, and is controlled by the triggering signal to record the corresponding dynamic image.

The active monitoring method with multi-spot image display includes the following steps. First, at least one dynamic image is obtained. Next, a triggering signal is generated according the obtained dynamic image. Finally, the triggering signal is used for controlling at least one display module to display the dynamic image. Furthermore, the triggering signal is used for controlling a main server to record the dynamic image.

The present invention uses the image-obtaining module and the image movement detection technology to detect object movement. When the object moves, the video and audio signal can be immediately compressed and transmitted to the receiving and converting transmission system on network and is displayed on the image-display module (such as computers, TVs, display screens, or cell phones) to show the living image in a picture in picture (PIP) mode or to inform the viewer by a scrolling banner. Therefore, a one-to-multiple (a video camera to a plurality of monitoring devices) or a multiple-to-multiple (a plurality of video camera to a plurality of monitoring devices) monitoring system is developed, the household safety monitoring system can be complete and digitized.

For further understanding of the invention, reference is made to the following detailed description illustrating the embodiments and examples of the invention. The description is for illustrative purpose only and is not intended to limit the scope of the claim.

### BRIEF DESCRIPTION OF THE DRAWINGS

The drawings included herein provide a further understanding of the invention. A brief introduction of the drawings is as follows:

FIG. 1 is a schematic diagram of the system structure of the present invention;

FIG. 2 is a flow chart of the active monitoring method with multi-spot image display of the present invention;

FIG. 3 is a block diagram of the image-obtaining module of the present invention; and

FIG. 4 is a block diagram of the image-receiving module of the present invention.

### DETAILED DESCRIPTION OF THE PREFERRED EMBODIMENTS

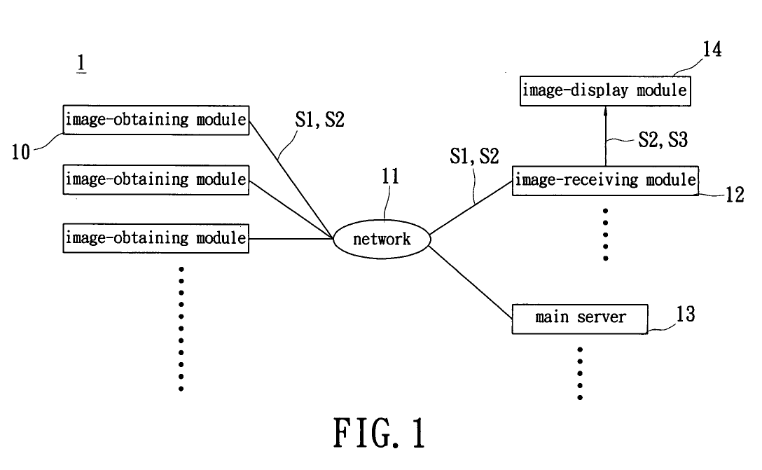

Reference is made to FIG. 1, which shows a schematic diagram of the system structure of the present invention. The active monitoring system with multi-spot image display 1 includes at least one image-obtaining module 10, at least one image-receiving module 12, and at least one image-display module 14. The image-obtaining modules 10 are linked to the image-receiving modules 12 via a network 11, and the image-receiving modules 12 are respectively connected with the image-display modules 14. The image-obtaining modules 10 respectively detect the object movements to obtain a dynamic image S1 and generate a triggering signal S2 according to the obtained dynamic image S1. The triggering signal S2 generated by the image-obtaining modules 10 is transmitted to each of the image-receiving modules 12 via the network 11 to control the image-receiving modules 12 to receive the corresponding dynamic image S1. At the same time, each of the image-receiving modules 12 decompresses the dynamic image S1 and transmits the processed dynamic image S3 to the corresponding image-display module 14. The image-display module 14 displays the processed dynamic image S3 according to the triggering signal S2.

Reference is made to FIG. 1 again. Each of the image-receiving modules 12 is connected with the corresponding image-display module 14 via a D-SUB interface and an AV interface, and the triggering signal S2 passes through the D-SUB interface to control the image-display module 14 to display the processed dynamic image S3. The processed dynamic image S3 passes through the AV interface and is transmitted to the image-display module 14. Furthermore, the active monitoring system with multi-spot image display 1 includes a main server 13. The main server 13 is connected with each of the image-obtaining modules 10 via the network 11, and is controlled by the triggering signal S2 to record the corresponding dynamic image S1 obtained by each of the image-obtaining modules 10.

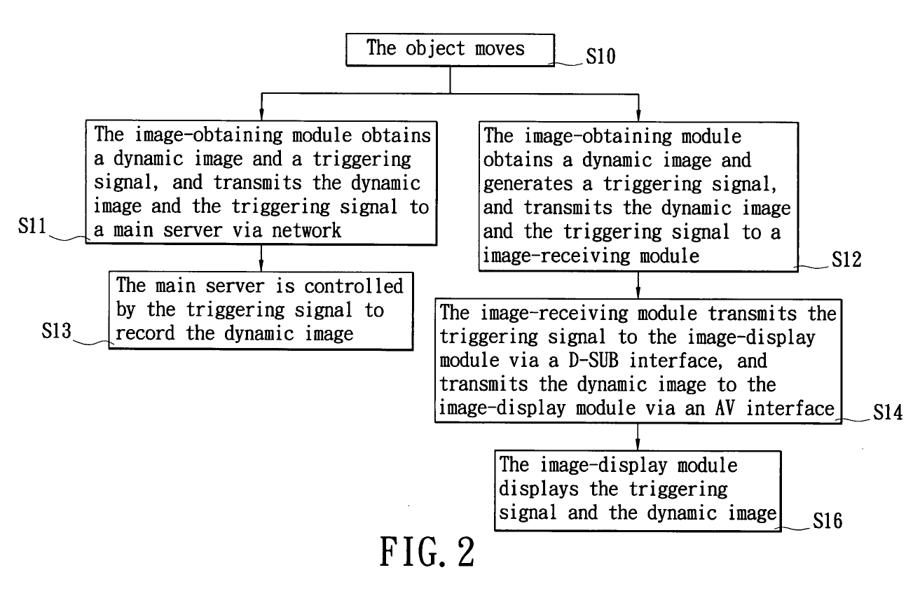

Reference is made to FIGS. 1 and 2. FIG. 2 is a flow chart of the active monitoring method with multi-spot image display of the present invention. First, when an object moves (S10), the image-obtaining module 10 generates a triggering signal S1 according to the obtained dynamic image S1, and transmits the dynamic image S1 and the triggering signal S2 to the image-receiving module 12 via network 11 (S12). Next, after the image-receiving module 12 receives the triggering signal S2, the image-receiving module 12 transmits the triggering signal S2 to the image-display module 14 via the D-SUB interface. At the same time, the image-receiving module 12 transmits the dynamic image S1 to the image-display module 14 via the AV interface (S14). Finally, the image-display module 14 displays the triggering signal S2 and the dynamic image S1 about 30 seconds.

Furthermore, when the object moves, the dynamic image S1 and the triggering signal S2 from the image-obtaining module 10 are transmitted to a main server 13 via network (S11). Next, the main server 13 is controlled by the triggering signal S2 to record the dynamic image S1 (S13).

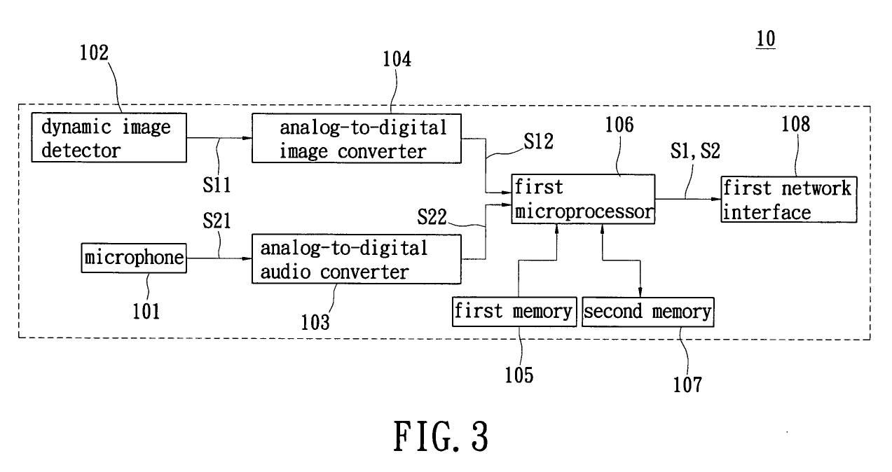

Reference is made to FIGS. 1 and 3. FIG. 3 is a block diagram of the image-obtaining module of the present invention. The image-obtaining module 10 includes a dynamic image detector 102, an analog-to-digital image converter 104, a microphone 101, an analog-to-digital audio converter 103, and a first microprocessor 106. The first microprocessor 106 is used as a control center, and an image-compression unit. The first microprocessor 106 is programmable, performs its operations according to the default program, and has the MPEG-4 and MJPEG compression functions. In an embodiment, the first microprocessor 106 is the F8120 processor from Faraday Technology Corporation.

Reference is made to FIGS. 1 and 3 again. The dynamic image detector 102 detects the movement of the object to generate analog image data S11. The analog-to-digital image converter 104 is connected with the dynamic image detector 102 for converting the analog image data S11 into digital image data S12. The microphone 101 obtains the audio signal to generate analog audio data S21. The analog-to-digital audio converter 103 is connected with the microphone 101 doe converting the analog audio data S21 into digital audio data S22. The first microprocessor 106 is connected with the analog-to-digital image converter 104 and the analog-to-digital audio converter 103 for receiving the digital image data S12 and the digital audio data S22, and outputting the triggering signal S2. At the same time, the first microprocessor 106 compresses the digital image data S12 and the digital audio data S22 to be the dynamic image S1. The dynamic image S1 is video-audio compressed data.

Reference is made to FIGS. 1 and 3 again. The image-obtaining module 10 further includes a first memory 105, a second memory 107, and a first network interface 108. The first memory 105, the second memory 107 and the first network interface 108 are connected with the first microprocessor 106. The first memory 105 is a non-volatile memory. In an embodiment, the first memory 105 is an EEPROM, or a flash memory, and is used for storing the control program of the first microprocessor 106. The second memory 107 is a volatile memory, and can be a SDRAM for storing the temporary data by the first microprocessor 106. The first network interface 108 can supports LAN-RJ45, WLAN, 802.11.a/b/g/n, power line and PoE.

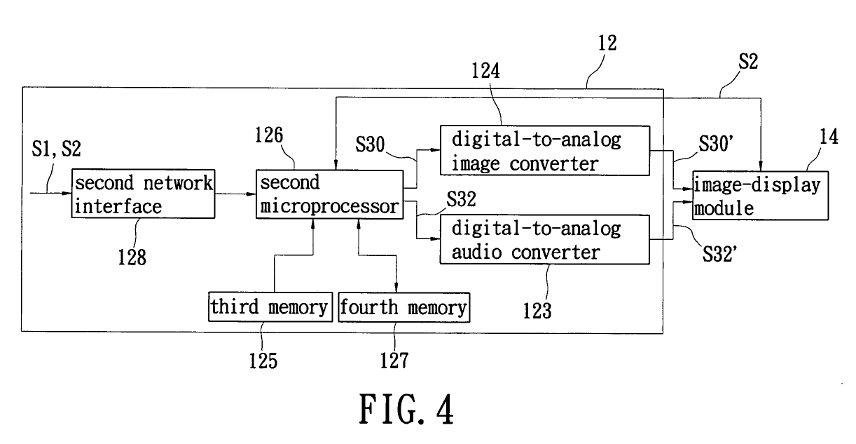

Reference is made to FIGS. 1, 3 and 4. FIG. 4 is a block diagram of the image-receiving module of the present invention. The image-receiving module 12 includes a second network interface 128, a second microprocessor 126, a digital-to-analog image converter 124, and a digital-to-analog audio converter 123. The second microprocessor 126 is the control center of the image-receiving module 12, and the image decompressing unit. The second microprocessor 126 is programmable, performs its operations according to the default program, and has the MPEG-4 and MJPEG decompression functions. In an embodiment, the second microprocessor 126 is the F8120 processor from Faraday Technology Corporation. The second network interface 128 can supports LAN-RJ45, WLAN, 802.11.a/b/g/n, power line and PoE.

Reference is made to FIGS. 1, 3 and 4 again. The second network interface 128 is connected with the network 11. The second microprocessor 126 is connected with the second network interface 128, the digital-to-analog image converter 124 and the digital-to-analog audio converter 123. The second microprocessor 126 receives the triggering signal S2 and the dynamic image S1 from the first microprocessor 106 of the image-obtain module 10 via the second network interface 128, the network 11 and the first network interface 128 of the image-obtain module 10. The second microprocessor 126 is controlled by the triggering signal S2 to decompress the dynamic image S1 to generate digital image playing data S30 and digital audio playing data S32.

The digital-to-analog image converter 124 connected between the second microprocessor 126 and the image-display module 14 converts the digital image playing data S30 into analog image playing data S30′ and transmits the analog image playing data S30′ to the image-display module 14. The digital-to-analog audio converter 123 connected between the second microprocessor 126 and the image-display module 14 converts the digital audio playing data S32 into analog audio playing data S32′ and transmits the analog audio playing data S32′ to the image-display module 14. The analog image playing data S30′ and the analog audio playing data S32′ contain the dynamic image S3 and are obtained from the dynamic image S1 being decompressed and processed by a digital-to-analog conversion operation. The processed dynamic image S3 is controlled by the triggering signal S2 and is displayed on the image-display module 14.

Reference is made to FIGS. 1, 3 and 4 again. The image-receiving module 12 further includes a third memory 125 and a fourth memory 127. The third memory 125 and the fourth memory 127 are connected with the second microprocessor 126. The third memory 125 is a non-volatile memory, and can be an EEPROM, or a flash memory and is used for storing the control program of the second microprocessor 126. The fourth memory 127 107 is a volatile memory, and can be a SDRAM for storing the temporary data by the second microprocessor 126.

Reference is made to FIGS. 1, 3 and 4 again. The image-obtaining module 10 uses the dynamic image detector 102 to obtain analog image data S11 for the analog-to-digital image converter 104. After the analog-to-digital image converter 104 converts the analog image data S11 into digital image data S12, the digital image data S12 is transmitted to the first microprocessor 106 to perform the image comparison and detection operation. The first microprocessor 106 also receives the digital audio data S22 via the analog-to-digital converter 103 from the microphone 101, and compresses the data into video-audio compressed data in a MPEG4 compression format and transmits the video-audio compressed data to the network 11 via the first network interface 108.

The second microprocessor 126 receives the triggering signal S2 and the video-audio compressed data transmitted by the image-obtaining module 10 from the network 11 via the second network interface 128. The second microprocessor 126 decompresses the video-audio compressed data and separates the video-audio compressed data into digital image playing data S30 and digital audio playing data S32. The digital image playing data S30 and the digital audio playing data S32 are respectively outputted to the image-display module 14 via the digital-to-analog image converter 124 and the digital-to-analog audio converter 123.

The active monitoring system with multi-spot image display and a method thereof of the present invention uses the image movement detection technology to detect object movement. When the object moves, the video and audio signal can be immediately compressed and transmitted to the receiving and converting transmission system on network and is displayed on the display screen or the TV to show the living image in a picture in picture (PIP) mode or to inform the viewer by a scrolling banner. Therefore, the active monitoring system with multi-spot image display is developed, and is used for a solution for the household safety monitoring system.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An active monitoring system with multi-spot image display, comprising:
one or more image-obtaining modules respectively obtaining a dynamic image and generating a triggering signal according to the obtained dynamic image;
one or more image-receiving modules connected with the image-obtaining modules via a network, wherein each of the image-receiving modules is controlled by the triggering signal to receive and process the dynamic image; and
one or more image-display modules respectively connected with the image-receiving modules, wherein the triggering signals respectively cause each of the image-display modules to display the processed dynamic images.

2. The active monitoring system with multi-spot image display as claimed in claim 1, wherein the image-obtaining module comprises:
a dynamic image detector for generating analog image data;
an analog-to-digital image converter connected with the dynamic image detector, wherein the analog-to-digital image converter converts the analog image data into digital image data;
a microphone for obtaining an audio signal to generate analog audio data;
an analog-to-digital audio converter connected with the microphone, wherein the analog-to-digital audio converter converts the analog audio data into digital audio data; and
a first microprocessor connected with the analog-to-digital image converter and the analog-to-digital audio converter for receiving the digital image data and the digital audio data and outputting the triggering signal, wherein the first microprocessor compresses the digital image data and the digital audio data into video-audio compressed data.

3. The active monitoring system with multi-spot image display as claimed in claim 2, wherein the image-obtaining module further comprises:
a first memory connected with the first microprocessor for storing an operation program of the first microprocessor;
a second memory connected with the first microprocessor for storing temporary data generated by the first microprocessor; and
a first network interface connected with the first microprocessor and the network.

4. The active monitoring system with multi-spot image display as claimed in claim 3, wherein the first memory is a non-volatile memory or a flash memory.

5. The active monitoring system with multi-spot image display as claimed in claim 3, wherein the second memory is a volatile memory.

6. The active monitoring system with multi-spot image display as claimed in claim 3, wherein the first network interface supports LAN-RJ45, WLAN, 802.11.a/b/g/n, power line, or PoE.

7. The active monitoring system with multi-spot image display as claimed in claim 3, wherein the image-receiving module comprises:
a second network interface connected with the network;
a second microprocessor connected with the second network interface, wherein the second microprocessor receives the triggering signal and the video-audio compressed data from the first microprocessor, and is controlled by the triggering signal to decompress the video-audio compressed data to generate digital image playing data and digital audio playing data;
a digital-to-analog image converter connected with the second microprocessor and the image-display module, wherein the digital-to-analog image converter converts the digital image playing data into analog image playing data for outputting to the image-display module; and
a digital-to-analog audio converter connected with the second microprocessor, wherein the digital-to-analog audio converter converts the digital audio playing data into analog audio playing data for outputting to the image-display module

8. The active monitoring system with multi-spot image display as claimed in claim 7, wherein the image-receiving module further comprises:
a third memory connected with the second microprocessor for storing an operation program of the second microprocessor; and
a fourth memory connected with the second microprocessor for storing temporary data generated by the second microprocessor.

9. The active monitoring system with multi-spot image display as claimed in claim 8, wherein the third memory is a non-volatile memory or a flash memory.

10. The active monitoring system with multi-spot image display as claimed in claim 8, wherein the fourth memory is a volatile memory.

11. The active monitoring system with multi-spot image display as claimed in claim 7, wherein the second network interface supports LAN-RJ45, WLAN, 802.11.a/b/g/n, power line, or PoE.

12. The active monitoring system with multi-spot image display as claimed in claim 1, further comprising a main server, wherein the main server is linked to each of the image-obtaining modules via the network, and is controlled by the triggering signal to record the dynamic image.

13. The active monitoring system with multi-spot image display as claimed in claim 1, wherein the triggering signal controls the image-display module via a D-SUB interface.

14. The active monitoring system with multi-spot image display as claimed in claim 1, wherein the processed dynamic image is transmitted to the image-display module via an AV interface.

15. An active monitoring method with multi-spot image display, comprising:
obtaining at least one dynamic image;
generating a triggering signal according the obtained dynamic image; and
controlling at least one display module by the triggering signal to display the dynamic image.

16. The active monitoring method with multi-spot image display as claimed in claim 15, wherein the triggering signal further controls a main server to record the dynamic image.

17. The active monitoring method with multi-spot image display as claimed in claim 15, wherein the triggering signal controls the image-display module via a D-SUB interface.

18. The active monitoring method with multi-spot image display as claimed in claim 15, wherein the processed dynamic image is transmitted to the image-display module via an AV interface.
